(19) United States
(12) Patent Application Publication
(10) Pub. No.: US 2018/0302812 A1
(43) Pub. Date: Oct. 18, 2018

(54) Inter-Technology Circuit-Switched Fallback (CSFB) Metrics

(71) Applicant: Telefonaktiebolaget LM Ericsson (publ), Stockholm (SE)

(72) Inventors: Inmaculada SERRANO GARCIA, Campanillas (Malaga) (ES); Raquel BARCO MORENO, Malaga (ES); Patricia DELGADO QUIJADA, Campanillas (Malaga) (ES); Omar KADDOURA MARIN, Campanillas (Malaga) (ES); David PALACIOS CAMPOS, Malaga (ES)

(21) Appl. No.: 15/766,569

(22) PCT Filed: Oct. 15, 2015
(86) PCT No.: PCT/EP2015/073866

§ 371 Date: Apr. 6, 2018

(51) Int. Cl. H04W 24/08; H04W 36/00

(52) U.S. Cl. CPC H04W 24/08; H04W 36/0022

(57) ABSTRACT

The present invention relates to the tracking of a transfer of voice calls from a source mobile communication network (10) to a target mobile communication network (20) when a circuit-switched fallback, CSFB, procedure is performed for the voice calls. The tracking is performed by acquiring (S110) trace data of the voice calls in both the source mobile communication network and the target communication network; and calculating (S140) at least one CSFB performance indicator based on the acquired call trace data.

### TECHNICAL FIELD

The present invention relates to a method, an apparatus, and a computer program for determining inter-technology circuit-switched fallback (CSFB) performance indicators (metrics). More particularly, the present invention relates to using call trace data of both the source and the target (legacy) communication network to determine an improved inter-technology CSFB metrics.

### BACKGROUND

The fast growth and expansion of novel mobile/wireless communication technologies, such as LTE (Long Term Evolution), has led the communication network to become an even more complex compound of subnetworks, where the newer ones overlap the already existing ones. In this context, rather than opposing each other, big efforts have been made to build a more reliable mobile communication network in which the older (legacy) mobile communication technology, like GSM or UMTS, based networks support the yet immature new mobile communication technologies, like LTE, based networks during the development of all their features.

Such is the case of voice traffic/calls in LTE, which as for now has been mostly supported by the Circuit-Switched (CS) side of the legacy technologies, GSM and UMTS, by means of two mechanisms, Circuit-Switched Fallback (CSFB) and Single Radio Voice Call Continuity (SRVCC).

In general, by CSFB mechanisms, the CS-domain services may be realized by reuse of CS infrastructure (radio and core network), and by CSFB is meant that a user equipment (UE) camps on a Packet-Switched (PS) system but switches over to a CS system to establish, for example, an originating CS call. For incoming terminating calls, on the other hand, the UE may be paged in the PS system, but may respond to the page in the CS system. The UE may thus, within CSFB, perform a registration, while in the PS-domain (e.g., LTE), to the CS domain. Once the UE then wants to make a CS voice call, or receives an incoming paging for a CS voice call, it will leave the PS-domain (LTE) and switches over to the CS radio access network and initiates the call setup in the CS network.

The first procedure (CSFB) is used when the user is in an area where the LTE voice service has not been deployed yet and redirects/transfers the outgoing or incoming call towards a legacy technology during the call setup. This procedure is currently responsible for the voice traffic during the first phase of VoLTE (Voice over LTE) deployment. The second phase of the complete VoLTE deployment is based on the SRVCC mechanism. It consists of handing over a VoLTE call towards a legacy technology once the voice connection between both users has been established. This procedure is basically an inter-system handover from a Packet-Switched (PS) domain to a CS domain.

However, the fact of one communications network relying on another network is not new. Inter-system or inter-RAT (Radio Access Technology) handovers have been widely studied since UMTS was coexisting with GSM during several years before LTE came in. In this context, inter-technology performance indicator have been defined which allows knowing how well a mobile communications technology complements the other. In Reference 1: UMTS performance measurement: A practical guide to KPIs for the UTRAN environment, Kreher, R. John Wiley & Sons, Chichester, UK, 2006. Ch. 2, Selected UMTS Key Performance Parameters, p. 137-147, ISBN 978-0-470-03249-7, some algorithms are proposed to identify third generation (3G) to second generation (2G) and 2G to 3G inter-RAT handovers for both CS and PS services, distinguishing the inter-RAT attempts from the successes and failures and thus defining the respective success and failure rates.

Regarding the LTE intra-system mobility management, some other performance indicators have been described. In Reference 2, Telecommunication management; Key Performance Indicators (KPI) for the Evolved Packet Core (EPC); Definitions, TS 32.455, 3GPP, 2014. Sect. 5.2, Mobility KPI, several Key Performance Indicators (KPIs) were defined for PS inter-RAT handover with UMTS and GSM as destination and source, while Reference 3, Telecommunication management; Performance Management (PM); Performance measurements Evolved Packet Core (EPC) network, TS 32.426, 3GPP, 2014. Sect. 4.1.10, Handover related measurements, describes the events in the LTE network that trigger the counters used in the KPI calculations from Reference 2. Further, in Reference 4, Ericsson RAN Analyzer User Manual, Rel. 15.2. Sect. 36.3, Mobility, a KPI for calculating the CSFB success rate based on the LTE network PM (Performance Management) counters is depicted.

### PROBLEMS WITH THE EXISTING SOLUTIONS

There are several procedures to transfer ongoing calls from one technology to another and, in the same way, some performance indicators have been defined to quantify the performance of these mechanisms. However, despite the fact that these procedures work inherently between two technologies, the information they gather/acquire, according to References 1-4, to compute these indicators come only from the source technology. In these cases, the reception in the source technology, such as LTE, of a message of acknowledgement from the target technology, such as GSM or UMTS, upon the incoming call notification is enough to consider the technology hop/transfer to be successful, at least in the side of the source technology. That is, the conventional performance indicators only ensure the call has been successfully released towards a legacy technology, not that the call has been successfully initiated in the legacy technology. In other words, a CSFB transfer comprises more than one stage, and the conventional mechanism to compute an inter-technology performance indicator is limited to the stage of call release towards the target (legacy) communication network, while the stage of call initiation in the target communication network and the successful establishment of a voice path in the target communication network is not considered.

### SOLUTION

Accordingly, it is an object of the present invention to solve the above described problems. In particular, it is an object of the present invention to overcome the above-described limitations and to provide metrics to evaluate the full CSFB call transfer.

A suitable method, an apparatus, and a computer program are defined in the independent claims. Advantageous embodiments are defined in the dependent claims.

Here, in order to ensure that the voice call which performed a technology hop such as CSFB enters, i.e. initiates, and successfully establishes a voice path, it is proposed to follow/track the voice path in both the source and target technology by acquiring voice call trace data, preferably by checking event flows associated with (i) the release toward, and (ii) initiating and (iii) establishing a voice path in the target technology.

A method is proposed for tracking voice calls from a packet-switched subsystem, such as LTE, to a circuit-switched subsystem of any of the legacy technologies, such as UMTS or GSM, when a Circuit-Switched Fallback, CSFB, is performed, using for that purpose acquired voice call trace data. Further, end-to-end CSFB-related metrics, such as the CSFB end-to-end success and failure rates, are proposed which will work as CSFB inter-technology performance indicators.

In one embodiment, a method is defined according to an embodiment for tracking a transfer of voice calls from a source mobile communication network to a target mobile communication network when a circuit-switched fallback, CSFB, procedure is performed for the voice calls, the method comprising the steps of: acquiring trace data of the voice calls in both the source mobile communication network and the target communication network; and calculating at least one CSFB performance indicator based on the acquired call trace data.

In another embodiment, an apparatus is defined according to an embodiment, and the apparatus is for tracking a transfer of voice calls from a source mobile communication network to a target mobile communication network when a circuit-switched fallback, CSFB, procedure is performed for the voice calls, the apparatus comprising an acquiring module configured to acquiring trace data of the voice calls in both the source mobile communication network and the target communication network; and a processing module configured to calculate at least one CSFB performance indicator based on the acquired call trace data.

In still further embodiments, a corresponding computer program is defined.

Here, the inter-technology CSFB-specific performance indicators, such as the CSFB success or failure rate, will be used to validate the CSFB mechanism as a reliable gateway for the voice traffic in the way of the complete VoLTE deployment.

The proposed mechanism thus enables an inter-technology call follow-up. In particular, when a call is transferred from one technology to another it is advantageous to be able to follow it up in its path (based on the acquired call trace data), so that its end-to-end event flow and cause of termination in the destination and source technologies are known. Here, the proposed mechanism provides a method to follow up CSFB calls from an LTE network (source network) to a legacy environment (target network).

The proposed mechanism relies on the information contained in the call trace data and thus provided by the event flows given by the same call from both source and target technologies. In particular, the event flow messages may allow the user to obtain an in-depth knowledge of the processes related to the ongoing call and thus, to define very specific and more accurate and reliable metrics, such as those defined herein. More specifically, the proposed metrics provide scalability as they may be used on a user-defined area, this is, a group of cells, one or more MME/RNC/BSC, or entire networks. In addition, the proposed metrics only use sums, products and divisions, and thus have low computational costs.

Furthermore, most of the registered events in the call trace data may be geo-localized. In a handover-related procedure such as CSFB, it is advantageous to be able to find both the source (LTE) and the target legacy networks call locations so that VoLTE geographical deployment issues can be studied in depth.

In general, the embodiments disclosed herein provide information beyond the one disclosed by the prior art on that a CSFB has failed based on network counters. Instead, the embodiments disclosed herein provide, e.g. to any of the managing system of a telecommunications network, information resulting of an evaluating all the relevant stages of the CSFB call transfer, and that additionally can provide a cause as to why, or at what event, in which network domain a transfer of a service has failed. The information can be utilized, for example, by the one or more apparatuses managing a telecommunications network to, for example, identify the particular traffic cases where a transfer of a communication between a source and a target network trend to fail, and to take the necessary management measures such as: increasing some network node's resources, modifying some network node's parameters, etc.

In addition, the proposed mechanism contribute to centralized, end-to-end intelligent platform to assist network operators in the efficient monitoring, design, optimization and troubleshooting of multi-vendor, multi-technology networks.

### BRIEF DESCRIPTION OF THE DRAWINGS

The embodiments herein will now be further described in more detail in the following detailed description by reference to the appended drawings illustrating the embodiments and in which:

FIG. 1 is a schematic flow diagram illustrating an embodiment of a method for tracking a transfer of voice calls when a CSFB procedure is performed.

FIG. 2 is a schematic diagram illustrating an embodiment of an apparatus for tracking a transfer of voice calls when a CSFB procedure is performed.

FIG. 3 is a schematic flow diagram illustrating another embodiment of a method for tracking a transfer of voice calls when a CSFB procedure is performed.

FIG. 4 is a schematic flow diagram illustrating another embodiment of a method for tracking a transfer of voice calls when a CSFB procedure is performed.

FIG. 5 is a schematic flow diagram illustrating another embodiment of a method for tracking a transfer of voice calls when a CSFB procedure is performed.

FIG. 6 is a schematic flow diagram illustrating a general overview of another embodiment of a method for tracking a transfer of voice calls when a CSFB procedure is performed.

FIG. 7 is a schematic flow diagram illustrating another embodiment of a method for filtering call trace data to determine calls that have been successfully released from the source communication network.

FIG. 8 is a schematic diagram illustrating an inter-technology overlapping area according to another embodiment.

FIG. 9 is a schematic diagram illustrating LTE and UMTS cell selection and the control of an inter-technology overlapping area according to another embodiment.

FIG. 10 is a schematic flow diagram illustrating another embodiment of a method for filtering call trace data to determine calls that have been successfully initiated in the target communication network.

FIG. 11 is a schematic flow diagram illustrating another embodiment of a method for filtering call trace data to determine calls for which a voice path has been successfully established in the target communication network.

FIG. 12 is a schematic flow diagram illustrating another embodiment of a method for using respecting call groups to determine one or more inter-technology performance indicators.

FIG. 13 is a schematic flow diagram illustrating another embodiment of a method for determining a signal condition in failed CSFB.

FIG. 14 is a schematic flow diagram illustrating another embodiment of a method for inter-technology call tracking.

### DESCRIPTION OF THE EMBODIMENTS

In the following, embodiments are described with reference to the appended Figures. It is noted that the following description contains examples only and should not be construed as limiting the invention. A person skilled in the art will recognize additional features and advantages upon reading the following detailed description. Further, similar or same reference signs indicate similar or same elements or operations.

The following proposes a mechanism for tracking voice calls from a source mobile communication network to a target communication network when a circuit-switched fallback, CSFB, procedure is performed for the voice calls. More specifically, the following describes the example of a CSFB procedure from LTE, as an example of a source mobile communication network, to another legacy technology, such as GSM or UMTS, as an example of a target mobile communication network, and its end-to-end performance metrics.

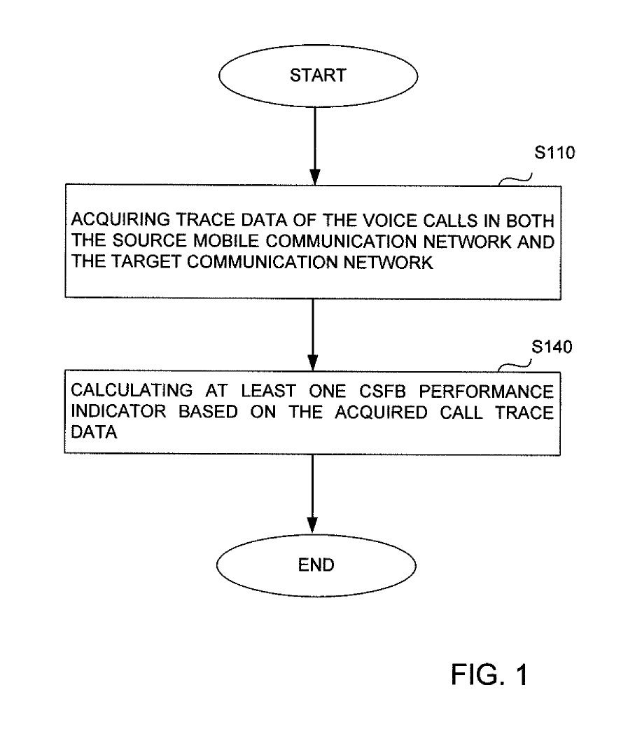

FIG. 1 illustrates an embodiment of a method for tracking a transfer of voice calls from a source mobile communication network 10 to a target mobile communication network 20 when a circuit-switched fallback, CSFB, procedure is performed for the voice calls. Here, the voice calls may be ongoing voice calls that are outgoing from a UE or incoming at a UE. The CSFB procedure may thus be performed from a PS domain (e.g., LTE) having a source RAT to a CS domain (e.g., UMTS, GSM) having a different, target RAT.

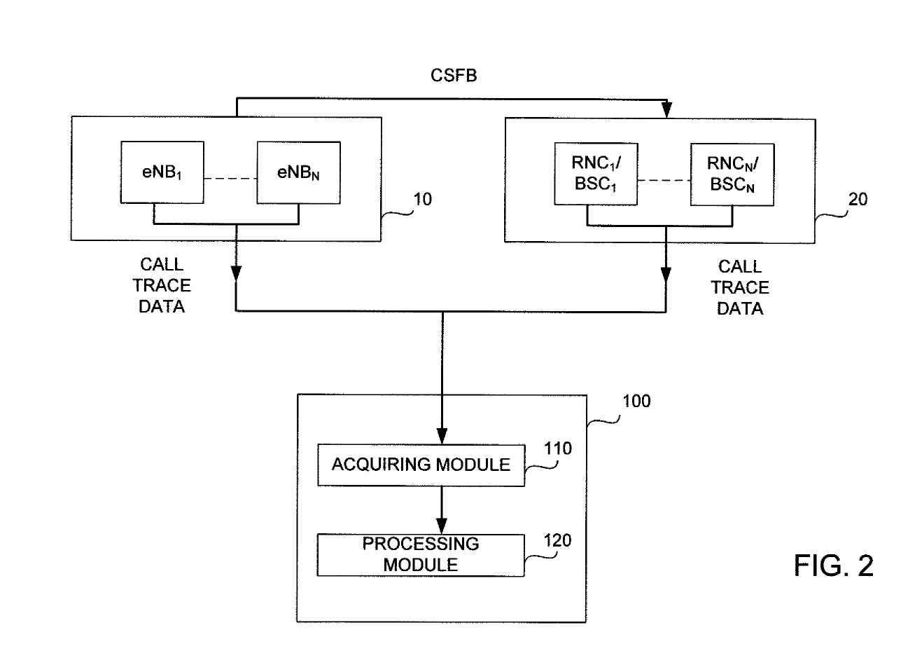

The method illustrated in FIG. 1 and further described below may be performed an apparatus 100 as illustrated in FIG. 2. As illustrated in FIG. 2, the source mobile communication network 10 (comprising respective eNBs) and the target mobile communication network 20 (comprising respective RNCs/BSCs) generate respective call trace data (as further described below), and the respective call trace data are acquired by an acquiring module 110 of the apparatus 100 that is in communicative interaction with both networks. As such, the apparatus 100 may be an integral part of the packet-switched source communication network 10 or it may be located outside of it. As further described below, the respective call trace data may be stored in call trace databases of the respective communication networks, and the acquiring module 110 acquires the call trace data by accessing those databases and collecting the call trace data. Alternatively or additionally, a corresponding database may be provided in the apparatus 100 itself, where the call trace data may be appropriately gathered, parsed and processed. Here, the apparatus 100 is further provided with a processing module 120 that is configured to calculate one or more CSFB performance indicator based on the acquired call trace data, as will be further described below.

As illustrated in FIG. 1, the method comprises a first step 5110 of acquiring trace data of the voice calls in both the source mobile communication network 10 and the target communication network 20. Here, the call trace data may be acquired or collected by or from the respective eNBs in the source domain (LTE) and the respective RNCs/BSCs to track an end-to-end flow being related to a transfer of a voice call path.

Here, as illustrated in FIG. 1, the method further comprises a second step S140 of calculating at least one CSFB performance indicator based on the acquired call trace data. Respective CSFB performance indicators refers to inter-technology performance indicators that require the analysis of call trace data with regard to both the source and target communication network. Such inter-technology performance indicators may thus be used to quantify how well the underlying CS-based voice traffic network supports the voice traffic deployment in LTE. For example, a CSFB end-to-end success rate and/or a CSFB end-to-end failure rate may be used to fully validate the CSFB procedure (mechanism) as a reliable gateway.

The mechanism and metrics proposed herein are thus based on acquiring and analyzing of call trace data to determine one or more inter-technology performance indicators. In general, the call trace data may comprise at least one of control information (and/or identification information) of the voice calls, voice call events, and a content of messages. Here, the control information may refer to at least one of a subscriber identity (IMSI), a mobile device identity (IMEI), a voice call identification, a voice call start time, and a voice call end time. The information with regard to voice call events may include at least one of a number of events being related to the voice call (identified by the voice call identification), an event identification, an event time, and an event description. Furthermore, a content of messages exchanged between the mobile network elements as part of the calls relates to messages of the events, and may, for example, include parameter values, data values, or the like.

Acquiring the thus defined voice call trace data may thus include call trace data gathering and processing, for example in respective databases being related to the source mobile communication network 10 and the target communication network 20. These respective databases may contain a list of calls with their relevant parameters, the sequence of events that took place for each one of these calls and the messages contained in these events, which are basically the information and commands the different entities in the cellular network send and receive in order to communicate with other network entities. TABLE 1 illustrates a sample list of calls with their relevant information contained in columns; some of these columns are IMSI and IMEI (as part of the control information), which identify the mobile user and the mobile device, respectively, others refer to the call identification, the call start and end times, and the number of related events.

Further, TABLE 2 below shows some of the events that compose the call with CALL ID=0 from TABLE 1, including an event identifier, event time, a short description and the content of a message it carries. Both tables would be part of the respective LTE and UMTS/GSM call databases.

Regarding the usage of voice call trace data, none of the above References 1-4 make use of them. Instead, they define their performance indicators based on network counters. Thus, in these cases, it is not possible to track a call between technologies, since the call leaves, for example, no trace of its identity (which usually comes as an IMEI or an IMSI) in the counter. Therefore, these conventional solutions present the disadvantage of a much lower diversity and accuracy of the algorithms designed for determining inter-technology performance indicators (metrics). “Lower diversity” refers here to the above-described prior art, concretely, References 2-4 which work with performance indicators derived from counters, which may be helpful for obtaining an overall idea of the status of the network but do not allow the user to focus on single call flows. That is, these solutions work with “how many times a certain message, event or situation took place in the network?” regardless of when and, even more, which call made that event to happen.

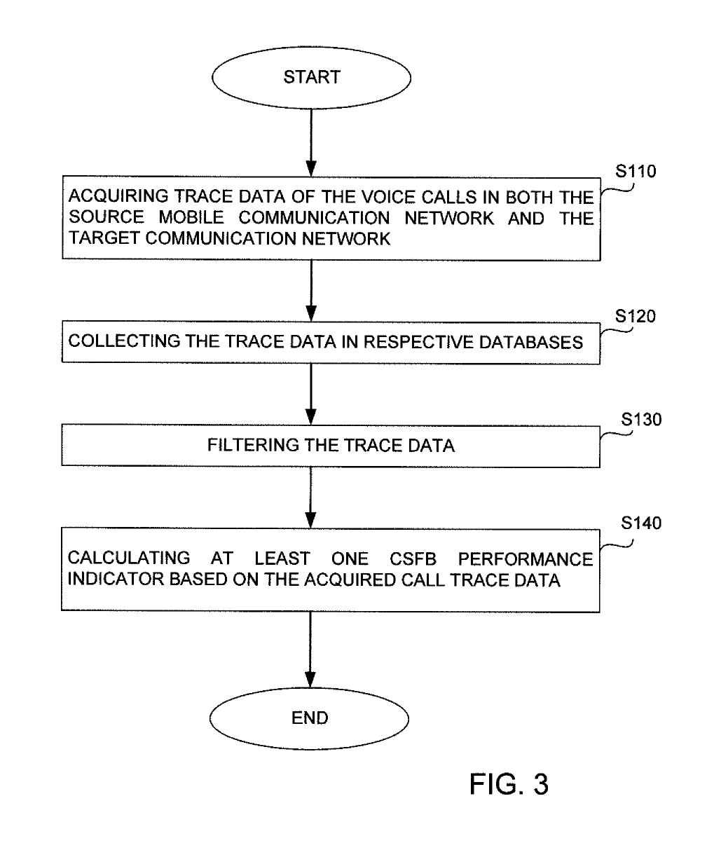

According to FIG. 3, a further embodiment may include the step S120 of collecting the call trace data in respective databases of the source mobile communication network 10 and the target communication network 20. The respective call trace data may thus be collected in respective databases of the source and target domain or a single database for both the source and target domain, and are then acquired for parsing the collected call trace data for further processing/analysis (e.g., to calculate one or more inter-technology performance indicators) by accessing the respective database. Here, the step of collecting and further processing of the call trace data may be performed by the management apparatus, which e.g. can be located in the PS source domain (e.g., LTE). Alternatively, the databases may be provided externally to the management apparatus which is provided with an interface to perform accesses to it.

According to FIG. 3, a further embodiment may include the step S130 of filtering the acquired trace data to determine a group of voice calls related to a release from the source mobile communication network 10, a group of voice calls related to an initiation of voice calls in the target mobile communication network 20, and a group of voice calls related to an establishment of a voice path in the target mobile communication network 20.

In particular, the step S130 of filtering may include a filtering of the trace data in/of the source mobile communication network 10 to determine a first group of voice calls for which a CSFB attempt has been triggered. In addition, the filtering may include the step of determining, from the first group, a second group of voice calls that have been successfully released from the source mobile communication network 10 and a third group of voice calls that have failed to be released from the source mobile communication network 10. Here, the filtering may be performed based on an iterative process that successively takes trace data, for example from the database related to the source network, and applies specific conditions to be met in order to sort the trace data in appropriate groups of voice calls, here a first group being related to CSFB attempts, a second group being related to a successful CSFB release toward the legacy domain, and a third group being related to failed CSFB attempts in the source domain.

In this context, the step of filtering S130 may comprise a step of setting an inter-technology overlapping area and determining whether a cell that serves the voice call in the source mobile communication network 10 is within the inter-technology overlapping area. In particular, the overlapping coverage area may be defined as an overlap of a coverage area of the source mobile communication technology and a coverage area of the target mobile communication technology for which call trace data have been collected in respective target cells of the target mobile communication technology. This overlapping coverage area is referred to as a call area constraint (which will be further described below). This means that only voice calls are used for determining the one or more inter-technology CSFB performance indicator (metrics) which have their origin in the overlapping coverage area. This is to distinguish from other calls that cannot be tracked in their target domain.

The step of filtering S130 as illustrated in FIG. 3 may further comprise the step of determining from the trace data in the source mobile communication network 10 whether the voice calls have an IMSI and/or an IMEI that is no null (non-zero) and whether the voice calls have a CSFB triggering event. This filter condition corresponds to a notification that those voice calls are, in fact, to be redirected to the target domain (UMTS/GSM), and determines the first group of voice calls, i.e. the CSFB attempts.

The step of filtering S130 as illustrated in FIG. 3 may further comprise the step of determining from the trace data in the source mobile communication network 10 whether the voice calls have been registered with more than a predetermined number of events, for example more than one event. Those calls with no more than a predetermined number of events are referred herein as spurious (e.g., the start and end time are the same) and are not further considered. On the other hand, the calls with more than a predetermined number of events have been properly registered in the call database(s), e.g. a call with more than one registered event. This also determines the first group of voice calls. This particular filter processing is performed in order to avoid LTE calls whose start and end cannot be found, as these instants are given by the first and last registered call event respectively.

The step of filtering S130 as illustrated in FIG. 3 may further comprise the step of determining from the trace data in the source mobile communication network 10 whether the voice calls have a CSFB release-notifying event. In the case of LTE, for example, there are some release-related events.

For example, as described in Section 5.3.5 from 3GPP TS 23.401 (V13.4.0, 2015), the resources-releasing procedure ends with the following events:
[ . . . ]
The MME releases the S1 interface by sending the S1 UE Context Release Command message to the eNodeB by means of the S1AP protocol.
The eNodeB confirms the S1 Release by returning an S1 UE Context Release Complete message to the MME by means of the S1AP protocol.

The last is an example of a release-related event that confirms the release of the resources in LTE.

This filter condition is applied in order to distinguish between just a release attempt and an actual successful release toward the target (legacy) domain. Depending on the result of this determination, the respective call is either added to the second group of voice calls or the third group of voice calls.

The step of filtering S130 as illustrated in FIG. 3 may further comprise the step of using the second group of voice calls, as determined above, and the trace data in the target mobile communication network 20 to determine a fourth group of voice calls that have been successfully initiated in the target mobile communication network 20. This may be achieved by comparing an IMSI and/or IMEI of the second group of voice calls with an IMSI and/or IMEI of the trace data of the voice calls in the target mobile communication network 20 and determining whether the voice calls in the target mobile communication network 20 start between a start time and an end time of the voice calls of the second group plus a time window Δ. Here, the time window Δ is a short time window of, for example 1 second, and may account for signaling delays and/or processing delays. If there is a match, i.e. if the voice call in the target mobile communication network 20 start between a start time and an end time of the voice calls of the second group plus a time window Δ, then this voice call is considered trackable and is added to the fourth group of voice calls (being classified as successfully initiated in the target domain). If there is no match, on the other hand, then the calls are classified as not trackable.

Based on the determined fourth group of voice calls, the step of filtering S130 as illustrated in FIG. 3 may further determine a fifth group of voice calls for which a predetermined event has been registered, for example sent or received, in the trace data of the voice calls in the target mobile communication network 20 and sixth group of voice calls for which a predetermined event has not been registered in the trace data of the voice calls in the target mobile communication network 20. Here, fifth group of voice calls are voice calls for which the network setup for the voice link is successfully established. On the other hand, the sixth group of voice calls refers to voice calls which are classified as failed CSFB calls in the target network. Examples of such predetermined events correspond to at least one of an alert, connect, call progress or disconnect message sent or received by an UE, as will be further described below.

The above step of calculating S140 as illustrated in FIG. 1 may further comprise the step of using at least one of the determined first group, third group, fifth group, and sixth group of voice calls to calculate the at least one CSFB performance indicator. This will be described in further detail below with regard to Eq. (3)-(11) that provide specific inter-technology performance indicators that depend on the voice call data of both the source and target network. Based on the specific inter-technology performance indicators it is, for example, not only possible to determine (based on the network counters) that a CSFB attempt has failed because it is possible to determine that the call has not been successfully released toward the legacy technology, but it is now possible to evaluate all stages of the CSFB call transfer and to additionally provide a cause as to why or at what event in which network domain a transfer has failed.

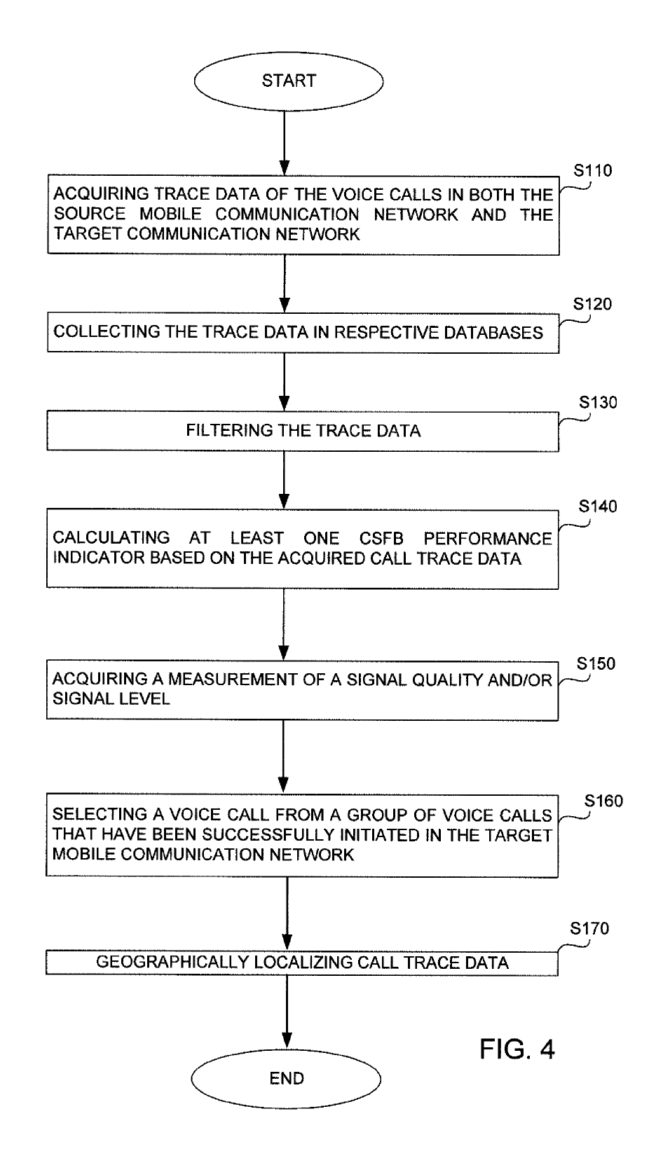

According to FIG. 4, a further embodiment may further comprise the step S150 of acquiring a measurement of a signal quality and/or signal level provided by the serving cell in the target communication network 20. This step S150 may be performed for the sixth group of voice calls, i.e. the group of voice calls that are associated with a failed CSFB in the target domain (UMTS/GSM). The measurement result may be taken from the last event in the call trace data that has reported a measurement of the signal quality and/or signal level. Here, the measurement time should be preferably within a time window T that is defined between the last registered event and a user-defined time (as will be described in more detail later). Subsequently, the acquired measurement result may be listed/displayed for the user to evaluate/troubleshoot the result. More specifically, the listed/displayed event flows messages allow the user to obtain an in-depth knowledge of the processes related to the ongoing call, in particular with regard to specific reasons as to the stage at which the CSFB call transfer has failed.

According to FIG. 4, the further embodiment may also include the step S160 of selecting a voice call from a group of voice calls that have been successfully initiated in the target mobile communication network 20 and chronologically ordering events of the respective voice call data. This step S160 may be performed for the fourth group of voice calls, i.e. the group of voice calls that are associated with a successful initiation in the target (legacy) network. Here, the selecting may be based on voice call identifications, such as IMSI, IMEI, call ID, as included in the call trace data. This procedure defines the complete inter-technology event flow, and provides the user with the capability to study in-depth the event flows from both network sides. This enables failure identification, e.g. the failure identification in the authentication process or the like.

According to FIG. 4, the further embodiment may also include the step S170 of geographically localizing call trace data, in particular geographically localizing respective registered events. The geolocation may be done by using certain information contained within the trace events, like measured cells, measured signal level, propagation delay and time delay measurements, along with the known geographic position of the cells. Based on this procedure, in a handover-related procedure such as CSFB, it becomes possible to find both the source LTE and the destination legacy call locations so that VoLTE geographical deployment issues may be studied in depth.

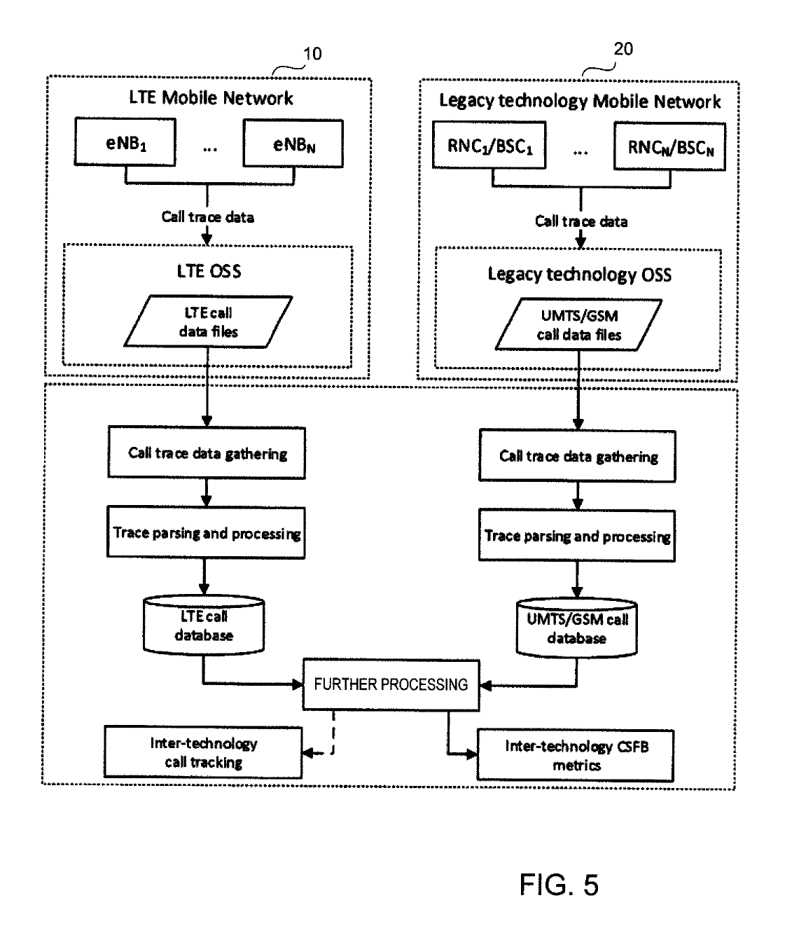

The following describes further embodiments. As illustrated in FIG. 5, these call trace data are first gathered by/from the eNBs (eNB₁, . . . eNB_{N}) in the LTE communication network (source mobile communication network) 10 and by/from the RNCs (RNC₁, . . . , RNC_{N}) or the BSCs (BSC₁, . . . , BSC_{N}) in the case of the legacy communication network (target communication network) 20. For example, the respective data may be collected in one or more databases (files) in their respective OSS.

As described above, the acquired call trace data may thus comprise logs of the control information, events and messages exchanged between the mobile network elements as part of the calls. A lot of useful technical information may be obtained or derived from the acquired call trace data, for example to monitor, troubleshoot and optimize the mobile networks, as will be further described below.

As further illustrated in FIG. 5, the call trace data may be gathered, parsed and processed, preferably by the apparatus 100 as illustrated in FIG. 2, so that two call databases may be generated: one for the source technology (e.g., LTE), and one for the target technology (e.g., UMTS/GSM).These databases are further used as input for a further processing (by the processing module 120 of the apparatus 100 in FIG. 2) that generated the inter-technology CSFB metrics (i.e. at least one CSFB performance indicator) and/or the capability of tracking calls between technologies, given as a set of pairwise LTE-legacy technology calls. As such, the main step in the call tracking procedure is identifying which call from the source technology corresponds to which call from the target technology in terms of their call identifier in their respective databases, so both sides of the call event flows can be matched afterwards. A set of pairwise LTE-legacy technology calls therefore refers to the pair of call identifiers (one for the call in the source technology and one for the call in the target technology) that allows the user to put together the two halves of the end-to-end call.

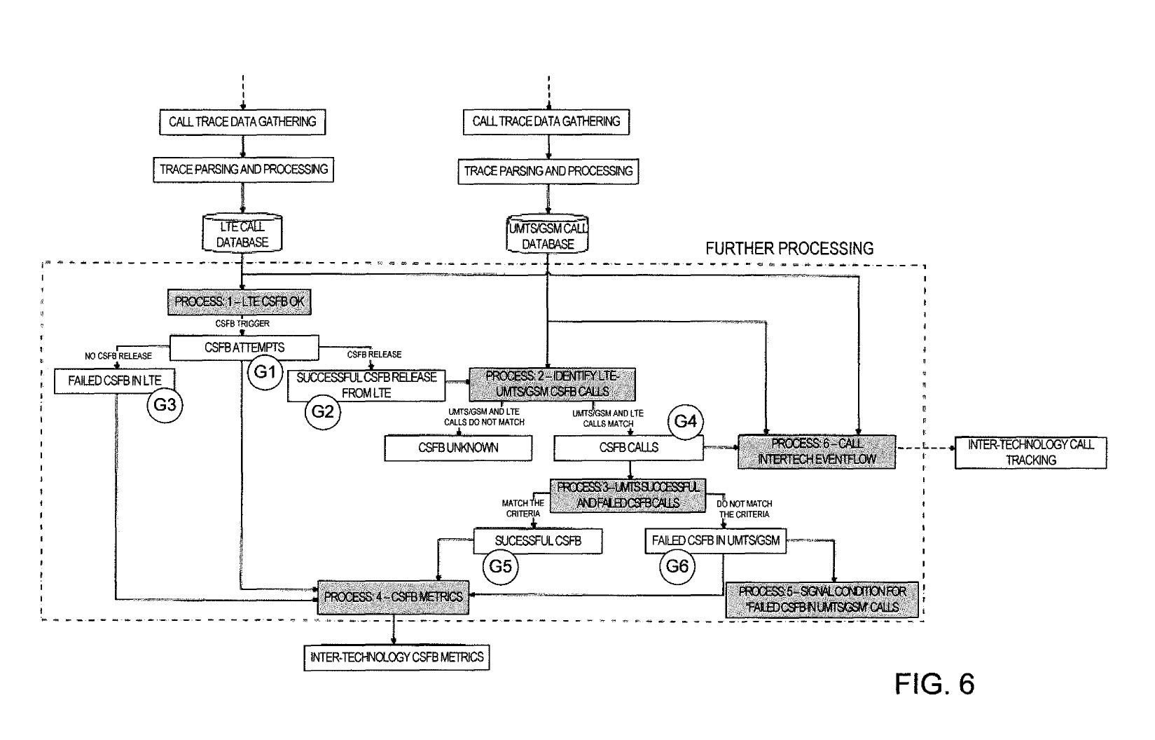

FIG. 6 shows a block diagram that summarizes the proposed embodiments described above, in particular in the context of classifying the voice calls into the respective first to sixth group (G1-G6). In FIG. 6, the blocks for data gathering and processing can be seen at the top for both technologies, followed by their respective call databases. These contain call trace data, in particular a list of calls with their more relevant parameters, the sequence of events that took place for each one of these calls and the messages contained in these events, which are basically the information and commands the different entities in the cellular network send and receive in order to communicate with other network entities, for example eNB₁ with eNB_{N} (as described above in Tables 1 and 2).

Continuing with FIG. 6, the block named Further Processing is shown after being broken down into a set of processes. They have been named PROCESS 1 to 6 and are shown in grey in FIG. 6. This block diagram also shows in white the groups of calls handled by the before mentioned processes.

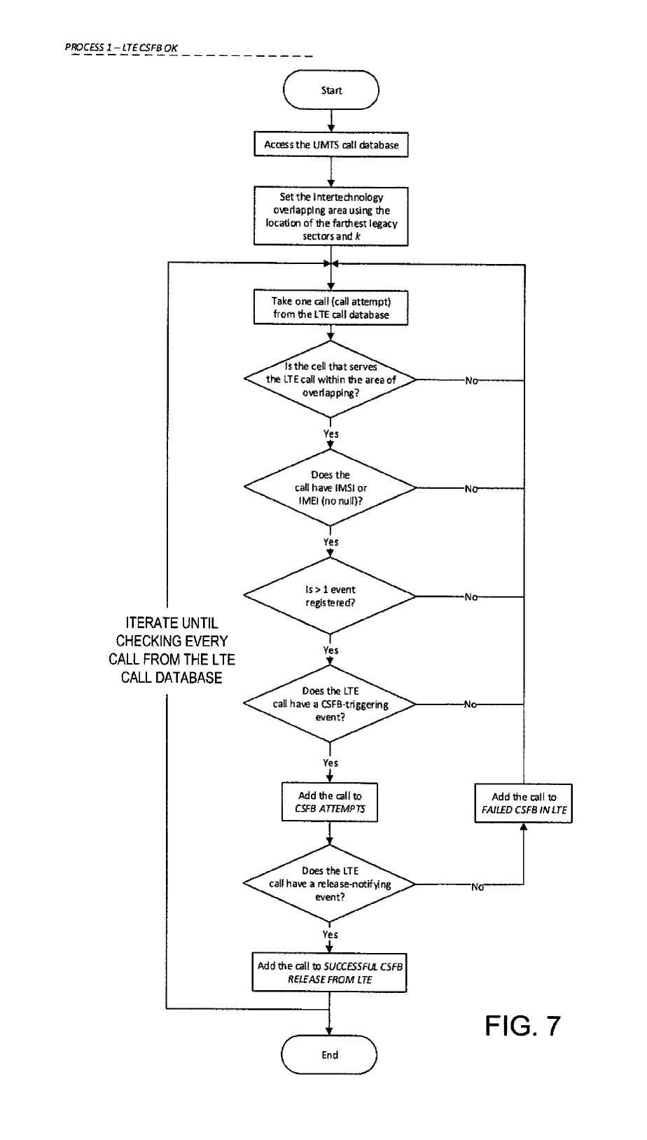

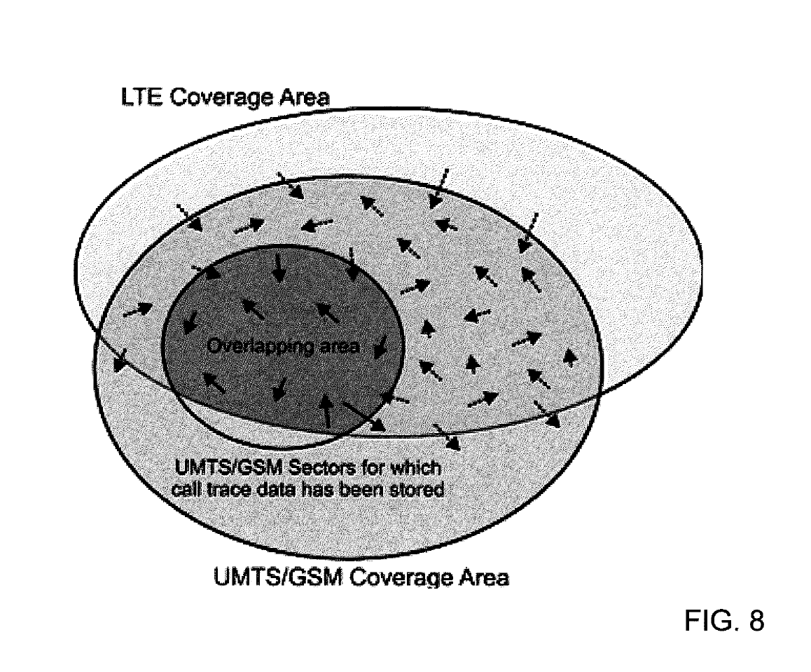

Regarding the logic of the Further Processing block in FIG. 6, first, PROCESS 1—LTE CSFB OK according to FIG. 7 identifies, based on an access to the LTE all database, the Mobile Originated/Mobile Terminated (MO/MT) LTE calls that start within the coverage area of the considered destination cells, i.e., the destination cells are those cells from the legacy technologies for which call trace data have been stored. It is noted that, according to FIG. 7, the UMTS call database has to be accessed only once in order to determine the location of the farthest UMTS sectors for which call trace data have been registered (which, eventually will allow the user to compute the upper limit of the inter-technology overlapping area, as described below). By contrast, the box “Take one call (call attempt) from the LTE call database” is executed for every iteration of the loop and represents the step in which the LTE call database is accessed. This process is done to ensure the legacy (destination) network has a coverage area completely surrounded by the coverage area of the LTE (source) network. To this purpose, an LTE call area constraint is set, i.e. an inter-technology area is set. This is shown in FIG. 8, which illustrates an overlapping of the LTE and legacy technology coverage areas, in particular, where the LTE coverage area is shaded in light grey and the UMTS/GSM is shaded in medium grey. Within this area there is a section where the call trace data has been stored. In this FIG. 8, the LTE CSFB calls are represented as arrows, whose tails (the source of the calls) come from the LTE coverage area and whose heads (the destination of the calls) point to the underlying UMTS/GSM coverage area. Only the LTE CSFB calls which have their origin inside the intersection (shaded in dark grey) of this last area and the LTE coverage area are to be considered to compute the proposed metrics. The arrows representing these calls are continuous, while the others are dashed. It is noted that not all the continuous arrows point inside the dark grey region; those calls which despite starting inside the dark grey region point outside it will account as unknown CSFB calls, since they cannot be tracked in their destination technology.

In FIG. 8 (PROCESS 1), the geographic area of interest is given by the rectangle defined by the farthest legacy sectors for which call trace data have been collected. Therefore, the inter-technology overlapping area is defined as the intersection of this area of interest with the LTE coverage area. At this point, the area of interest (rectangle) can be reduced to avoid the effect of the LTE sectors from the edge. That is, those sectors which are more likely to redirect their CSFB calls towards legacy sectors for which no data have been stored. This area reduction is controlled by the parameter k, defined between 0 and 0.5, where k=0 stands for the upper limit of the area and k=0.5 stands for a single point in the center of the rectangle defined by the farthest UMTS sectors. The described area of interest is therefore limited by a minimum and a maximum latitude and longitude defined by:

Long|Latₘᵢₙ_{ₐᵣₑₐ}=Long|Latₘᵢₙ_{_{RNC}}+k·(Long|Latₘₐₓ_{_{RNC}}−Long|Latₘᵢₙ_{_{RNC),}}

Long|Latₘₐₓ_{ₐᵣₑₐ}=Long|Latₘₐₓ_{_{RNC}}−k·(Long|Latₘₐₓ_{_{RNC}}−Long|Latₘᵢₙ_{_{RNC),}} (1)

where Long|Lat_{min|max}_{ₐᵣₑₐ} stands for the minimum or maximum longitude or latitude (depending on the case) used to define the rectangle-shaped boundary of the geographic area of interest and Long|Lat_{min|max}_{_{RNC}} stands for the minimum or maximum longitude or latitude of the sectors in the legacy technology for which the call traces have been collected.

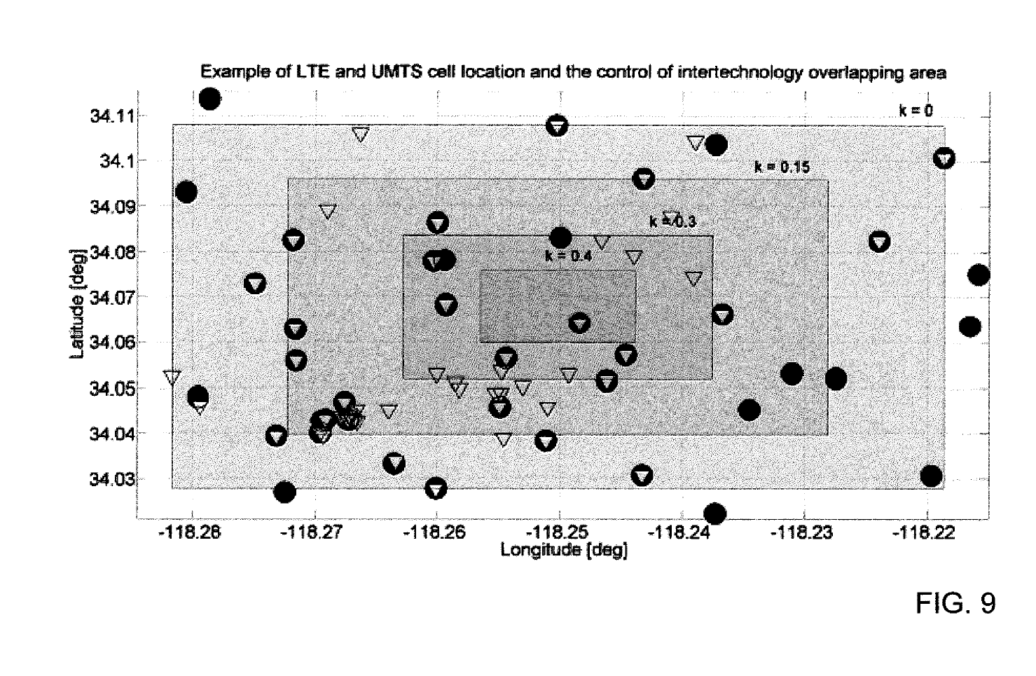

FIG. 9 shows an example of LTE and UMTS cell location and the control of the inter-technology overlapping area using UMTS as the destination technology, according to the location of the farthest legacy sectors and the reduction control parameter k. The UMTS sectors are shown in white triangles; the LTE sectors, in black circles and four inter-technology overlapping areas in light grey for the parameter k=0, 0.15, 0.3 and 0.4 respectively. The coverage area for LTE exceeds the region shown in FIG. 9 so that the overlapping areas coincide with the shadowed regions.

Further, according to FIG. 7 and the access to the LTE call database, respective calls (call attempts) are iteratively taken from the LTE call database, and respective filter processes are performed.

In a first filtering process, it is determined whether the cell that serves the LTE call is within the inter-technology overlapping area (as a first condition to be met). If this is not the case (No), then the next call is retrieved from the LTE call database. On the other hand, if the cell that serves the LTE call is within the inter-technology overlapping area (Yes), then another filtering process is performed to determine whether the call has a non-zero IMSI or IMEI (as a second condition to be met). In addition, it may be determined from the call trace data whether the LTE call has a CSFB-triggering event. In other words, by taking only those LTE call attempts within this inter-technology overlapping area into account, that is, those originated in the LTE sectors bounded by one of the shadowed areas, PROCESS 1 keeps only (filters out) those calls with a no-null IMSI or IMEI and a CSFB triggering event which notifies that those calls are to be redirected to UMTS/GSM. Those calls are being added to a CSFB ATTEMPTS group, i.e. a first group of voice calls for which a CSFB attempt has been triggered.

Once this first group of calls is identified, PROCESS 1 may apply two more filter processes, as illustrated in FIG. 7. In particular, a filter processing is performed to select only those calls that are not considered as spurious. In this context a call may be considered as spurious if its events have not been properly registered in the call database, e.g., a call with only a limited (pre-determined) number of events in the call trace data, for example with only one event (e.g. as illustrated in FIG. 7). Accordingly, only the calls with more than one event registered pass this filter to determine the first group of voice calls.

According to FIG. 7, another filter process may be performed to check which calls perform a successful LTE release towards the legacy technology. This may be notified by means of one or more events in their event flow, i.e. a release-notifying event. if this condition is fulfilled (Yes), the LTE call is considered as successfully released and is added to a second group of calls named SUCCESSFUL CSFB RELEASE FROM LTE. If they are not (No), then the call is added to the third group of calls named FAILED CSFB IN LTE, as there was a CSFB attempt but not a release.

The above filter processing of FIG. 7 is iteratively performed for every call from the LTE call database,

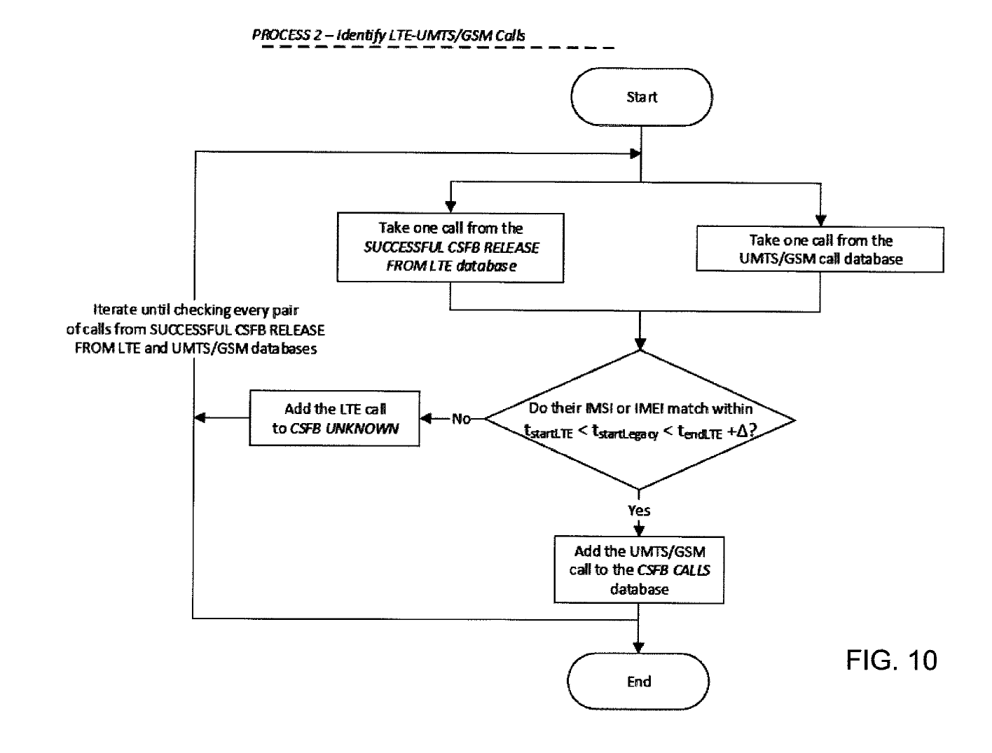

Having determined the first, second, and third group of voice calls by the filter processing of the call trace data of the LTE call database, as described above for PROCESS 1 of FIG. 7, the further processing according to PROCESS 2 of FIG. 10 determines a fourth group of voice calls that have been successfully initiated in the target mobile communication network, as will be described below.

In particular, PROCESS: 2—Identify LTE-UMTS/GSM CSFB according to FIG. 10 includes a comparison of the IMSIs and/or IMEIs from the SUCCESSFUL CSFB RELEASE FROM LTE calls (second group of voice calls) and those corresponding to respective calls from the UMTS/GSM CALL DATABASE. If they match and the UMTS/GSM (legacy) call starts at a time (t_{start/legacy}) between the start time (t_{start/LTE}) and the end time (t_{end/LTE}) of the LTE call plus a short time window, Δ, the UMTS/GSM call is redirected to a fourth group of voice calls named CSFB CALLS. Here, the fourth group of voice calls may be in a specific database, or the respective calls may be appropriately associated (e.g., flagged, linked, etc.) in their respective databases. This time window Δ after the end of the LTE call is added to include in the fourth group (CSFB CALLS) those calls whose UMTS/GSM start time was registered (because of a time delay) some tenths of a second afterwards. The time window is preferably short enough to ensure the delay is due to signal propagation or a message processing and registering time issue and not because of a voluntary call retry performed by the calling user. This is given by (2):

tₛₜₐᵣₜ_{_{LTE}}<tₛₜₐᵣₜ_{_{legacy}}<t_{end}_{_{LTE}}+Δ. (2)

As further illustrated in FIG. 10, in case their IMSI or IMEI could not be matched during this time window the calls are classified into a CSFB UNKNOWN set of voice calls, as it was not possible to track the destination for the LTE-released call.

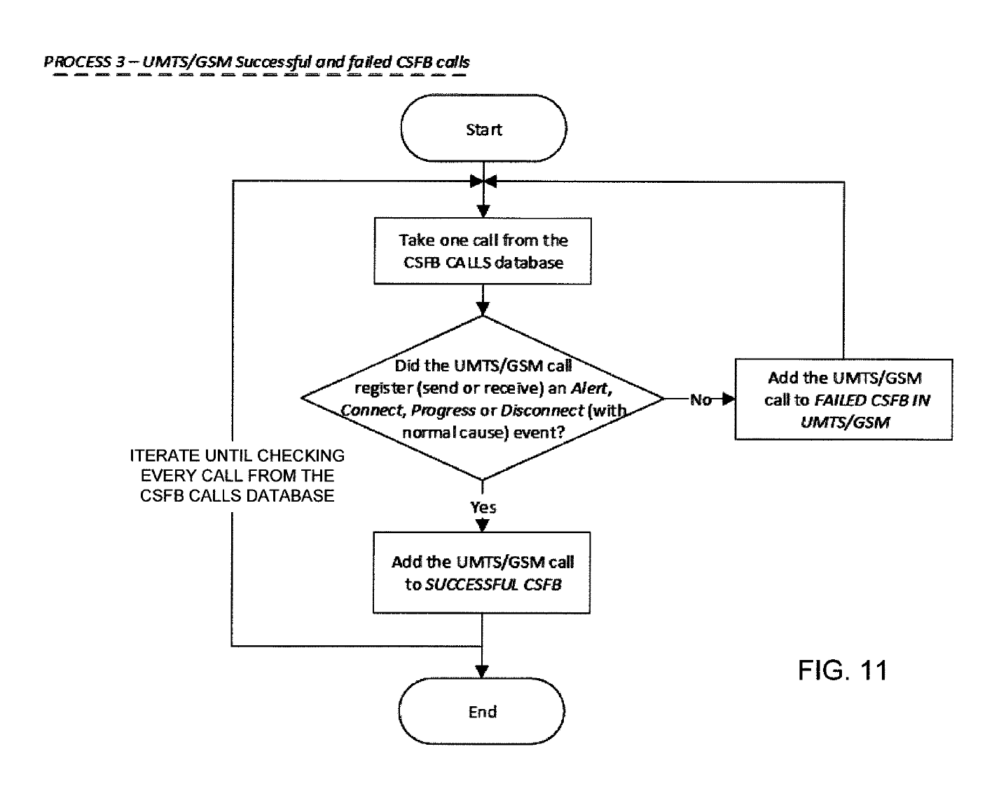

Having determined the fourth group of voice calls by matching control information (IMSI and/or IMEI) within a time window, as described above for PROCESS 2 of FIG. 10, to determine whether voice calls have been successfully initiated in the target domain, the further processing according to PROCESS 3 of FIG. 11 determines a fifth and a sixth group of voice calls in the context of the successful/failed establishing of voice paths in the target domain, as will be described below.

In particular, PROCESS: 3—UMTS/GSM successful and failed CSFB calls according to FIG. 11 includes an identification of the CSFB failures and successes in the UMTS/GSM environment (target domain). A CSFB is considered as end-to-end successful and therefore, labeled as SUCCESSFUL CSFB in a fifth group of voice calls, once the network setup for the voice link is established. This is done by PROCESS: 3—UMTS/GSM successful and failed CSFB calls (FIG. 11) which takes respective calls (call trace data) from the fourth group of voice calls, and looks therein for messages of Alert, Connect, Call Progress or Disconnect (with a cause for disconnection not related to admission control or traffic issues) sent or received by the UE, depending on the case. If the UMTS/GSM call (of the fourth group) registered (send or received) such an event (Yes), then the UMTS/GSM call is added to the fifth group of voice calls (SUCCESSFUL CSFB) indicating that a network setup for the voice link is successfully established. On the other hand, if such a special event is not registered, i.e. if none of these cases takes place (No), then the UMTS/GSM call is added to the sixth group of voice calls (FAILED CSFB in UMTS/GSM).

The reasons why these messages and the corresponding special events have been chosen are explained below:

Alert message: This message is sent in the RNC/BSC-CN direction in the MO side and in the opposite direction in the MT side. It is used to notify that the ongoing call has reached the stage where the destination UE begins to ring. At this point, the Core

Network in the MT side has accepted the incoming call and a voice Radio Access Bearer has been set up.

Call Progress. During the call setup, the call may leave the PLMN/ISDN environment; e.g., because of interworking with another network, with a non-PLMN/ISDN user, or with non-PLMN/ISDN equipment within the called user's premises; the call may also return to a PLMN/ISDN environment. When such situations occur, the network sends a progress indicator information element to the calling mobile station either: (a) in an appropriate call control message, if a state change is required (e.g. Alert or Connect), (b) in the Progress message, if no state change is appropriate.

Connect: The call is automatically accepted and the UE receives a Connect message with no Alert message preceding it. This situation takes place when the user calls some service of automatic attendance, like an assisted call service, which usually requires in-band DTMF dialing.

Disconnect/Call Clearing: The network initiates the call clearing at the radio interface to the mobile which originated the call. Under normal conditions, the call control entity of the mobile station or of the network initiates call clearing by sending a Disconnect message to its peer entity. To prevent considering disconnections related to the lack of network resources or protocol errors, only disconnections with normal causes are commonly considered, these are “user busy”, “no user responding”, etc. A Disconnect message can also be sent in the UE-CN direction. This means the UE wants to end the call and, therefore, that there was a voice call, which means the CSFB was also successful.

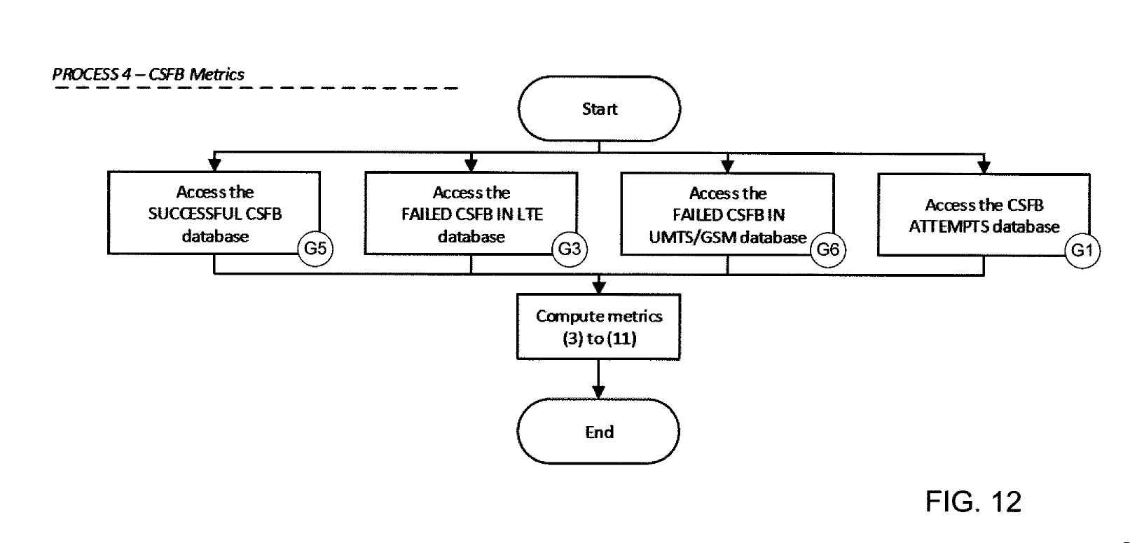

Once all the calls with a CSFB attempt are grouped into successful, failed or unknown CSFB, PROCESS: 4—CSFB Metrics (according to the flow diagram of FIG. 12) uses four groups of calls, corresponding to SUCCESSFUL CSFB (fifth group), FAILED CSFB IN LTE (third group), FAILED CSFB IN UMTS/GSM (sixth group) and CSFB ATTEMPTS (first group) to compute at least one of the following inter-technology performance parameters/metrics (3) to (11). It is noted that the operator |A| stands for the cardinality (number of elements) of the set A.

$$\begin{matrix}Total number of CSFB attempts = \vert CSFB ATTEMPTS \vert & ( 3 ) \\ CSFB failures = \vert FAILED CSFB IN UMTS / GSM \vert + \vert FAILED CSFB IN LTE \vert & ( 4 ) \\ UMTS / GSM CSFB failure rate [ \% ] = 100 \cdot \frac{CSFB failures}{Total number of CSFB attempts} & ( 5 ) \\ Failed CSFB call average duration in legacy technology [ s ] == \frac{\sum Failed CSFB call duration in legacy technology}{\vert FAILED CSFB IN UMTS / GSM \vert} & ( 6 ) \\ Unknown CSFB = \vert CSFB ATTEMPTS \vert - \vert SUCCESSFUL CSFB \vert - CSFB failures & ( 7 ) \\ Unknown CSFB rate [ \% ] = 100 \cdot \frac{Unknown CSFB}{Total number of CSFB attempts} & ( 8 ) \\ Successful CSFB = \vert SUCCESSFUL CSFB IN UMTS / GSM \vert & ( 9 ) \\ CSFB success rate [ \% ] = 100 \cdot \frac{Successful CSFB}{Total number of CSFB attempts} & ( 10 ) \\ Successful CSFB call average duration in legacy technology [ s ] == \frac{\sum Successful CSFB call duration in legacy technology}{\vert SUCCESSFUL CSFB \vert} & ( 11 )\end{matrix}$$

As may be taken from the above, the defined inter-technology performance parameters/metrics are derived based on information (call trace data) from both the source and target communication network.

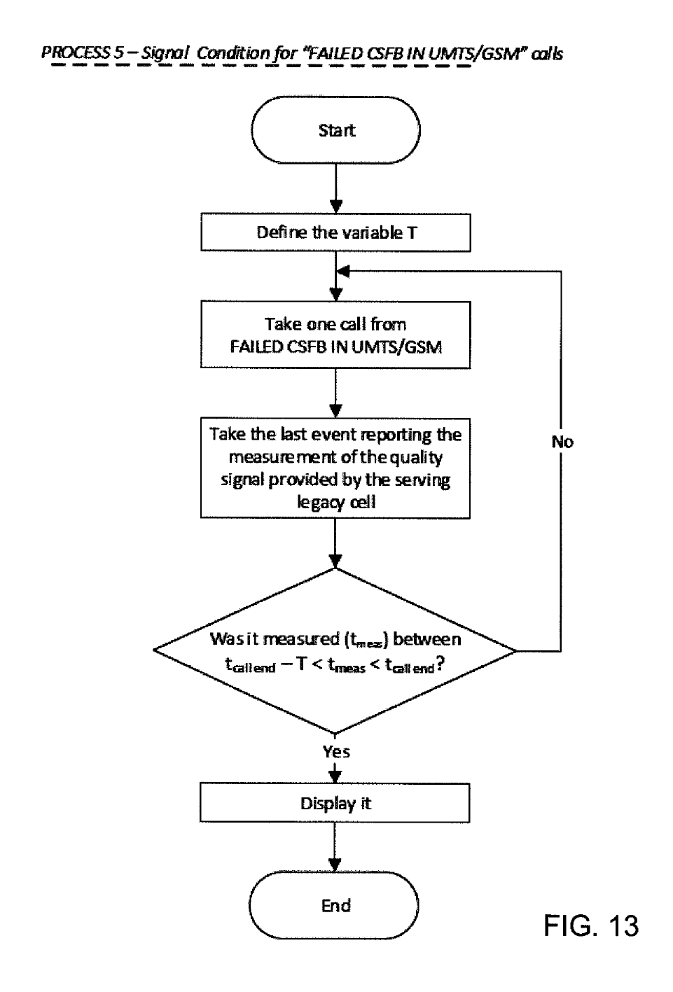

Further, once the CSFB calls have been classified into successful, failed and unknown and their respective metrics have been computed, as described above, two more optional actions that can help in troubleshooting of the failed CSFB calls may be taken. The first mechanism, contained in PROCESS: 5 Signal condition for “FAILED CSFB IN UMTS/GSM CALLS” and further illustrated in FIG. 13, consists of listing the last measurement of the signal quality and/or signal level provided by the serving cell in the legacy technology, within a time window T defined between the last registered event and a user-defined time. More specifically, by iteratively taking calls from the sixth group of voice calls (“FAILED CSFB IN UMTS/GSM”), an event (for example the last event) reporting the measurement of the signal quality provided by the serving legacy cell is taken, and it is determined whether the quality signal is measured at a time point (tₘₑₐₛ) in the interval defined by the last registered event (t_{call end}) and the time window T. If this is the case, then this last measurement is listed/displayed, for example at a corresponding user display of the apparatus (management system).

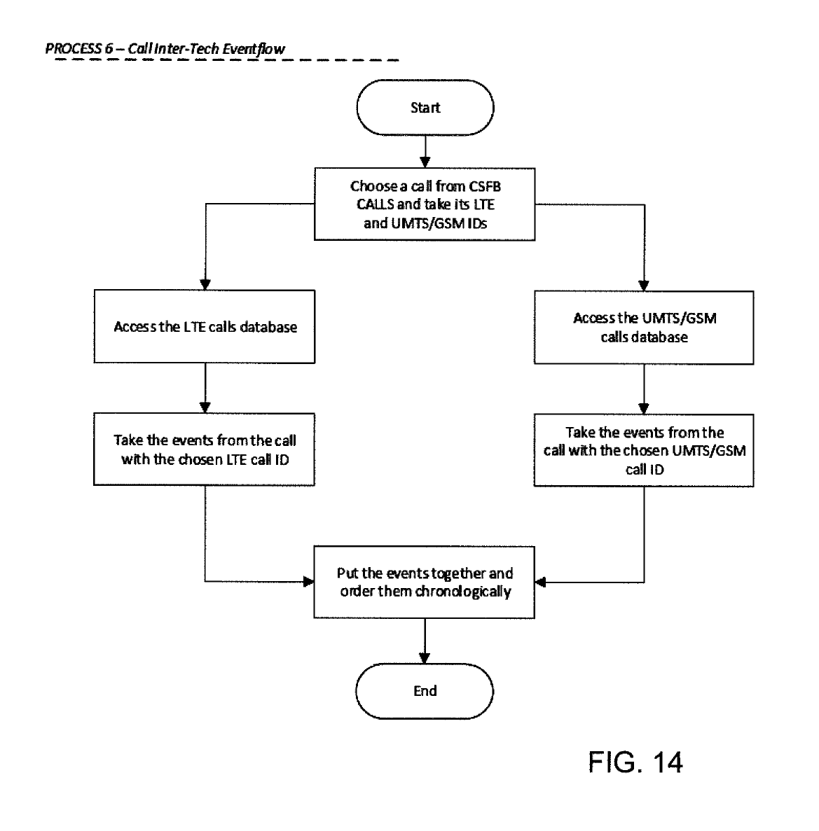

The second optional mechanism consists of listing chronologically the sequence of end-to-end events and their parameters for a single problematic call. This proposal is contained in PROCESS: 6—Call Inter-Tech Eventflow. More specifically, according to FIG. 14 which shows the flow diagram for PROCESS 6, by taking respective calls from the, fourth group of voice calls (“CSFB CALLS”) and by taking LTE and UMTS/GSM identification numbers, the respective LTE calls database and UMTS/GSM calls database is accessed, the respective events acquired in the call trace data are taken with the selected call IDs (compare with Tables 1 and 2) and the events are put together in a chronological order, i.e. a set of pairwise LTE-legacy technology calls as described above. This enables failure identification, for example the identification of a failure in the authentication process.

Below, further specific data are provided and discussed with regard to the proposed tracking mechanism described above. To that purpose, the respective call databases from two live time and space co-located LTE and UMTS networks have been used. Here, the considered LTE network comprises 19879 cells, while the UMTS network, for which only a RNC has been considered, comprises 4515 cells. This highlights again the importance of setting an inter-technology overlapping area to avoid considering those CSFB attempts that came from LTE cells which are far from the observed legacy sectors and which will contribute to increase the number of untraceable or unknown CSFB calls.

Table 3 below shows the results of computing metrics (3) to (11), described above, over three fifteen-minute periods of time using the reduction parameter k=0.15, 0.3 and 0.4 and using the delay parameter (time window) Δ=0 and 1.5 seconds. As it can be seen, as the parameter k for edge cell effect removal is increased for a fixed Δ, the number of unknown CSFB calls tends to decrease. This occurs at the expense of considering a lower number of CSFB call attempts; only those call attempts within the ever-decreasing inter-technology overlapping area (when k is increased). In the same way, if the value of k is held in a period of time, the number of unknown CSFB calls is always lower for Δ=1.5 s than for Δ=0. It can be seen how the rows with the maximum k and Δ present no unknown CSFB call. That is, every CSFB call attempt in the dataset is labeled as a failure or a success.

Further, attending to the CSFB call end-to-end success rate, (10), it can be seen how the results oscillate over 85% in most cases, reaching a 100% of success for k=0.4 and Δ=1.5 in the third period of time. These results allow validating the CSFB as a mechanism for relying LTE voice traffic on the CS subsystems of the legacy technologies.

In addition, TABLES 4 and 5 below show the result of executing PROCESS 5 and 6 (described above in FIGS. 13-14) over the dataset above. In both cases, k and Δ were set to 0.3 and 1.5 s respectively. In TABLE 4, two failed CSFB calls in UMTS are listed in the first fifteen-minute period of time and only one per period is shown for 16:15-16:30 and 16:45-17:00. As it can be seen in TABLE 3, the number of failed CSFB calls for these periods, (4), is 2, 2 and 3. In that context it may be noted that although a call may have been classified as failed, there may not be a signal measurement event within the time window defined between the last registered event and the user-defined time, Moreover, the result from Eq. (4) accounts for the calls that failed either in LTE or in UMTS/GSM (the sum of the number of calls failed in both sides). However, only those failures that took place in the UMTS/GSM side are to be listed here. Eq. (4) may output 3 failures, but maybe only one of them took place in the UMTS/GSM side, and therefore, only that may be an output of PROCESS 5. The reason TABLE 4 only shows one measurement for the last two periods is that these are the only measurements within the user-defined time window, that is, T=5 seconds before the end of the call. In this case, the measured received signal code power (RSCP) and measured signal level Ec/N₀ are shown.

TABLE 5 below shows a piece of the end-to-end call event flow for the failed CSFB call from period 16:15 to 16:30 from TABLE 4. Attending to the event parameters it can be extracted that no alert, connect, progress or disconnect messages were traded, so it is considered that the call did not establish a voice path in the legacy technology. Taking a deeper insight into the event parameters, it can be seen that the call did not progress due to a failure in the authentication procedure. In this table, a thick black line delimits the end of the LTE event flow and the start of the UMTS one.

The above respective modules may be implemented by a processing unit that include one or a plurality of processors, a microprocessor or other processing logic that interprets and executes instructions stored in a main memory. The main memory may include a RAM or other type of dynamic storage device that may store information and instructions for execution by the respective modules/units. For example, the acquiring module 110 and/or the processing module 120 discussed above with respect to FIG. 2 may be realized by the processing unit. The ROM may include a ROM device or another type of static storage device that may store static information and instructions for use by the processing unit.

As mentioned above, the apparatus 100 may perform certain operations or processes (filtering, acquiring, parsing, collecting, etc.) described herein. The apparatus 100 may perform these operations in response to the processing unit executing software instructions contained in a computer-readable medium, such as the main memory, ROM and/or storage device. A computer-readable medium may be defined as a physical or a logical memory device. For example, a logical memory device may include memories within a single physical memory device or distributed across multiple physical memory devices. Each of the main memory, ROM and storage device may include computer-readable media with instructions as program code. The software instructions may be read into the main memory for another computer-readable medium, such as a storage device or from another device via the communication interface.

The software instructions contained in the main memory may cause the processing unit(s) including a data processor, when executed on the processing unit, to cause the data processor to perform operations or processes described herein. Alternatively, hard-wired circuitry may be used in place or on in combination with the software instructions to implement processes and/or operations described herein. Thus, implementations described herein are not limited to any specific combination of hardware and software.

The physical entities according to the different embodiments of the invention, including the elements, units, modules, nodes and systems may comprise or store computer programs including software instructions such that, when the computer programs are executed on the physical entities, steps and operations according to the embodiments of the invention are carried out, i.e. cause data processing means to carry out the operations. In particular, embodiments of the invention also relate to computer programs for carrying out the operations/steps according to the embodiments of the invention, and to any computer-readable medium storing the computer programs for carrying out the above-mentioned methods.

Where the term module is used, no restrictions are made regarding how distributed these elements may be and regarding how gathered these elements may be. That is, the constituent elements/modules/units of the apparatus 100 may be distributed in different software and hardware components or other devices for bringing about the intended function. A plurality of distinct elements/modules may also be gathered for providing the intended functionality. For example, the elements/modules/functions of the UE/nodes may be realized by a microprocessor and a memory similar to the above node including a bus, a processing unit, a main memory, ROM, etc. The microprocessor may be programmed such that the above-mentioned operation, which may be stored as instructions in the memory, are carried out.

Further, the elements/modules/units of the apparatus may be implemented in hardware, software, Field Programmable Gate Arrays (FPGAs), Application-Specific Integrated Circuits (ASICs), firmware or the like.

It will be apparent to those skilled in the art that various modifications and variations can be made in the entities and methods of this invention as well as in the construction of this invention without departing from the scope or spirit of the invention.

The invention has been described in relation to particular embodiments and examples which are intended in all aspects to be illustrative rather than restrictive. Those skilled in the art will appreciate that many different combinations of hardware, software and/or firmware will be suitable for practicing the present invention.

Moreover, other implementations of the invention will be apparent to those skilled in the art from consideration of the specification and practice of the invention disclosed herein. It is intended that the specification and the examples be considered as exemplary only, wherein abbreviations used in the above examples are listed below. To this end, it is to be understood that inventive aspects lie in less than all features of a single foregoing disclosed implementation or configuration. Thus, the true scope and spirit of the invention is indicated by the following claims.

The invention has been described in relation to particular embodiments and examples which are intended in all aspects to be illustrative rather than restrictive. Those skilled in the art will appreciate that many different combinations of hardware, software and/or firmware will be suitable for practicing the present invention.

### ABBREVIATIONS

BSC Base Station Controller
CS Circuit-Switched
CN Core Network
CSFB Circuit-Switched Fallback
DTMF Dual-Tone Multi-Frequency
eNB Evolved Node B
GSM Global System for Mobile Communications
IMEI International Mobile System Equipment Identity
IMSI International Mobile Subscriber Identity
ISDN Integrated Services Digital Network
KPI Key Performance Indicator
LTE Long Term Evolution
MME Mobility Management Entity
MO Mobile Originated
MT Mobile Terminated
OSS Operation Support System
PLMN Public Land Mobile Network
PM Performance Management
PS Packet-Switched
RAT Radio Access Technology
RNC Radio Network Controller
SRVCC Single Radio Voice Call Continuity
UE User Equipment
UMTS Universal Mobile Telecommunications System
UTRAN UMTS Radio Access Network
VoLTE Voice over LTE

1.-20. (canceled)

21. A method for tracking a transfer of voice calls from a source mobile communication network to a target mobile communication network when a circuit-switched fallback, CSFB, procedure is performed for the voice calls,
the method comprising the steps of:
acquiring trace data of the voice calls in both the source mobile communication network and the target communication network;
calculating at least one CSFB performance indicator based on the acquired call trace data
acquiring a measurement of a signal quality and/or signal level provided by the serving cell in the target communication network.

22. The method according to claim 21, wherein the measurement result of a signal quality and/or signal level is acquired from the last event in the call trace data that has reported a measurement of the signal quality and/or signal level.

23. The method according to claim 21, wherein the trace data comprise control information of the voice calls, voice call events, and a content of messages related to the voice call events.

24. The method according to claim 21, further comprising the step of collecting the trace data in respective databases of the source mobile communication network and the target communication network.

25. The method according to claim 21, further comprising the step off filtering the trace data to determine a group of voice calls related to a release from the source mobile communication network, a group of voice calls related to an initiation of voice calls in the target mobile communication network, and a group of voice calls related to an establishment of a voice path in the target mobile communication network.

26. The method according to any one of claim 25, wherein the step of filtering comprises a step of filtering the trace data in the source mobile communication network to determine a first group of voice calls for which a CSFB attempt has been triggered, and to determine, from the first group, a second group of voice calls that have been successfully released from the source mobile communication network and a third group of voice calls that have failed to be released from the source mobile communication network.

27. The method according to claim 26, wherein the step of filtering comprises a step of setting an inter-technology overlapping area and determining whether a cell that serves the voice call in the source mobile communication network is within the inter-technology overlapping area.

28. The method according to claim 27, further comprising the step of determining from the trace data in the source mobile communication network whether the voice calls have an IMSI and/or an MEI and whether the voice calls have a CSFB triggering event.

29. The method according to claim 28 further comprising the step of determining from the trace data in the source mobile communication network whether the voice calls have been registered with more than a predetermined number of events.

30. The method according to claim 29, further comprising the step of determining from the trace data in the source mobile communication network whether the voice calls have a CSFB release-notifying event.

31. The method according to claim 26, wherein the step of filtering further comprises the step of using the second group of voice calls and the trace data in the target mobile communication network to determine a fourth group of voice calls that have been successfully initiated in the target mobile communication network.

32. The method according to claim 31, further comprising the step of comparing an IMSI and/or IMEI of the second group of voice calls with an IMSI and/or IMEI of the trace data of the voice calls in the target mobile communication network and determining whether the voice calls in the target mobile communication network start between a start time and an end time of the voice calls of the second group plus a time window (Δ).

33. The method according to claim 31, further comprising the step of determining, from the fourth group of voice calls, a fifth group of voice calls for which a predetermined event has been registered in the trace data of the voice calls in the target mobile communication network and sixth group of voice calls for which a predetermined event has not been registered in the trace data of the voice calls in the target mobile communication network.

34. The method according to claim 33, wherein the predetermined event is an event corresponding to at least one of an alert, connect, call progress or disconnect message sent or received by an UE.

35. The method according to claim 26, further comprising the step of using at least one of the determined first group, third group, fifth group, and sixth group of voice calls to calculate the at least one CSFB performance indicator.

36. The method according to claim 21, further comprising the step of selecting a voice call from a group of voice calls that have been successfully initiated in the target mobile communication network and chronologically ordering events of the respective voice call data.

37. The method according to claim 21, further comprising the step of geographically localizing call trace data.

38. An apparatus for tracking a transfer of voice calls from a source mobile communication network to a target mobile communication network when a circuit-switched fallback, CSFB, procedure is performed for the voice calls, the apparatus comprising a processor and a memory, the memory containing instructions executable by the processor such that the apparatus is operative to:
acquire trace data of the voice calls in both the source mobile communication network and the target communication network;
calculate at least one CSFB performance indicator based on the acquired call trace data
acquire a measurement of a signal quality and/or signal level provided by the serving cell in the target communication network.

39. The apparatus of claim 38, wherein the measurement result of a signal quality and/or signal level is acquired from the last event in the call trace data that has reported a measurement of the signal quality and/or signal level.

40. Computer program including instructions configured, when executed on one or a plurality of data processors, to cause the data processor or the plurality of data processors to execute the method of claim 21.
